(19) United States
(12) Patent Application Publication
(10) Pub. No.: US 2015/0039800 A1
(43) Pub. Date: Feb. 5, 2015

(54) ELECTRONIC APPARATUS, BASE AND METHOD OF SWITCHING PIN FUNCTIONS OF CONNECTOR

(71) Applicant: PEGATRON CORPORATION, Taipei City (TW)

(72) Inventor: Wei-Chen LEE, Taipei City (TW)

(21) Appl. No.: 14/444,951

(22) Filed: Jul. 28, 2014

(30) Foreign Application Priority Data
Jul. 31, 2013 (TW) 102127506

(51) Int. Cl. G06F 1/16; G06F 13/40

(52) U.S. Cl. CPC G06F 1/1632; G06F 13/4068
USPC 710/303

(57) ABSTRACT

An electronic apparatus comprises a processing unit, a second connector, a sensing module and a route-selecting module. The second connector is electrically connected with the processing unit and is capable of being forward or reverse inserted with a first connector of a base. The sensing module is provided for generating different control signals according to the forward insertion or the reverse insertion between the second connector and the first connector. The route-selecting module is electrically connected with the sensing module for switching a usage status of the second connector according to different control signals.

### CROSS-REFERENCE TO RELATED APPLICATIONS

This Non-provisional application claims priority under 35 U.S.C. §119(a) on Patent Application No(s). 102127506 filed in in Taiwan, R.O.C. on Jul. 31, 2013, the entire contents of which are hereby incorporated by reference.

### BACKGROUND OF THE INVENTION

1. Field of the Invention

This invention relates to an electronic apparatus or a base and, more particularly, to an electronic apparatus or a base provided for allowing a processing unit to be still capable of performing a signal transmission with an expansion device when two connectors are forward or reverse inserted with each other.

2. Description of the Related Art

As the technology is developing rapidly, the portable electronic products have become the main streams in which tablet and smart phone are the most reprehensively portable products in the recent years. Comparing the previous notebook with the tablet, the advantage of the tablet is light, thin and easily carried, but it is not very convenient for typing of office work due to the touch interface for typing. In order to dissolve this inconvenient, the industry develops an expansion base, which has an expansion device and a connector, only for the tablet. The connector is provided to be electrically connected with a connector of the tablet for allowing information typed by a user can type through a keyboard to be transmitted to the tablet via two connectors.

In the current designs of most bases and electronic apparatuses, the processing unit only can perform a signal transmission with the expansion device of the base when the two connectors are forward inserted with each other. Please refer to FIG. 1, and FIG. 1 is a schematic view showing the design of an electronic apparatus 1a and a base 90a in the prior art. In the prior art, the processing unit 10a of the electronic apparatus 1a can be electrically connected with the expansion device 91a of the base 90a through the insertion between the second connector 20a and the first connector 92a. It presumes that an input/output terminal 11a (number 2) of the processing unit 10a is provided for outputting a signal to an input/output contact 911a (number 2′) of the expansion device (that is, the input/output terminal 11a (number 2) is output and the input/output contact 911a (number 2′) is input), the input/output contact 911a (number 2′) is electrically connected with a first transmission pin 921a (number b′) of the first connector 92a. At that time, the input/output terminal 11a (number 2) of the processing unit 10a needs to be electrically connected with a second transmission pin 21a (number b) of the second connector 20a to allow the signal outputted from the input/output terminal 11a (number 2) to be transmitted to the input/output contact 911a (number 2′) after the second connector 20a is forward contacted with the first connector 92a. In order to accomplish the abovementioned signal transmission even when the second connector 20a is reverse inserted with the first connector 92a, the second transmission pin 21a (number i), which is symmetric to the second transmission pin 21a (number a) will be designed to be electrically connected with the input/output terminal 11a (number 2). Accordingly, the signal outputted from the input/output terminal 11a (number 2) still can be transmitted to the input/output contact 911a (number 2′) through the contact between the second transmission pin 21a (number i) of the second connector 20a and the input/output contact 911a (number a) of the first connector 92a even through the second connector 20a is reverse inserted with the first connector 92a.

By the abovementioned method, however, double amount of transmission pins is needed for achieving the purpose of transmitting signal during both the forward insertion and the reverse insertion. Once the request for the signal transmission between the processing unit 10a and the expansion device 91a is larger, the amount of the pins of the second connector 20a will be more amazing. For example, there are 10 of the input/output terminals 11a of the processing unit 10a needed to be connected with the input/output contacts, the second connector 20a needs 21 of the second transmission pins 21a. Therefore, the volume of the connector is too huge to be practically applied.

### BRIEF SUMMARY OF THE INVENTION

A main aspect of the present invention is to provide an electronic apparatus or a base for allowing a processing unit to be still capable of performing a signal transmission with an expansion device when two connectors are forward or reverse inserted with each other.

Another aspect of the present invention is to provide a method of switching pin functions of connector.

To achieve the main aspect of the present invention, an electronic apparatus of the present invention is detachably connected with a base. The base comprises an expansion device and a first connector electrically connected with the expansion device. The electronic apparatus of the present invention comprises a processing unit, a second connector, a sensing module and a route-selecting module.

The processing unit comprises a plurality of input/output terminals. The second connector is capable of being forward or reverse inserted with the first connector and comprises a plurality of second transmission pins. The sensing module is provided for generating a first control signal when the second connector is forward inserted with the first connector and for generating a second control signal when the second connector is reverse inserted with the first connector. The route-selecting module is connected with the sensing module and provided for conducting a first route set according to the first control signal or for conducting a second route set according to the second control signal to allow each of the second transmission pins to be electrically connected with each of the input/output terminals through, selectively, the conduction of the first route set or the second route set, in which a sort of the first route set and the second route set, respectively, corresponding to each of the input/output terminals is different and a sort of the first route set and the second route set, respectively, corresponding to each of the second transmission pins is the same so that the processing unit can perform a signal transmission with the expansion device through, respectively, the conduction of the first route set or the second route set when the second connector is forward or reverse inserted with the first connector.

The base of the present invention is detachably connected with an electronic apparatus. The electronic apparatus comprises a processing unit and a second connector electrically connected with the processing unit. The base of the present invention comprises an expansion device, a first connector, a sensing module and a route-selecting module.

The expansion module comprises a plurality of input/output contacts. The first connector is capable of being forward or reverse inserted with the second connector and comprises a plurality of first transmission pins. The sensing module is provided for generating a first control signal when the second connector is forward inserted with the first connector and for generating a second control signal when the second connector is reverse inserted with the first connector. The route-selecting module is connected with the sensing module and provided for conducting a first route set according to the first control signal or for conducting a second route set according to the second control signal to allow each of the first transmission pins to be electrically connected with each of the input/output contacts through, selectively, the conduction of the first route set or the second route set, in which a sort of the first route set and the second route set, respectively, corresponding o each of the input/output contacts is different and a sort of the first route set and the second route set, respectively, corresponding to each of the first transmission pins is the same so that the processing unit can perform a signal transmission with the expansion device through, respectively, the conduction of the first route set or the second route set when the second connector is forward or reverse inserted with the first connector.

To achieve another aspect of the present invention, the method of switching pin functions of connector of the present invention is provided for allowing a processing unit of an electronic apparatus to be still capable of performed a signal transmission with an expansion device of a base when a second connector of the electronic apparatus is forward or reverse inserted with a first connector of the base. The processing unit comprises a plurality of input/output terminals, and the second connector comprises a plurality of second transmission pins. Each of the second transmission pins is electrically connected with each of the input/output terminals through, selectively, the conduction of the first route set or the second route set, in which a sort of the first route set and the second route set, respectively, corresponding to each of the input/output terminals is different and a sort of the first route set and the second route set, respectively, corresponding to each of the second transmission pins is the same. The method of the present invention comprises the following steps: a control signal is generated when the second connector is inserted with the first connector, in which the control signal is different according to the forward insertion or the reverse insertion between the second connector and the first connector. And further, a step of conducting one of a first route set or a second route set according to the control signal is performed.

According to another embodiment of the present invention, the method of switching pin functions of connector of the present invention is provided for allowing a processing unit of an electronic apparatus to be still capable of performed a signal transmission with an expansion device of a base when a second connector of the electronic apparatus is forward or reverse inserted with a first connector of the base. The expansion device comprises a plurality of input/output contacts, and the first connector comprises a plurality of first transmission pins. Each of the first transmission pins is electrically connected with each of the input/output contacts through, selectively, the conduction of the first route set or the second route set, in which a sort of the first route set and the second route set, respectively, corresponding to each of the input/output contacts is different and a sort of the first route set and the second route set, respectively, corresponding to each of the first transmission pins is the same. The method of the present invention comprises the following steps: a control signal is generated when the second connector is inserted with the first connector, in which the control signal is different according to the forward insertion or the reverse insertion between the second connector and the first connector. And further, a step of conducting one of a first route set or a second route set according to the control signal is performed.

### BRIEF DESCRIPTION OF THE DRAWINGS

FIG. 1 is a structure drawing showing an electronic apparatus and a base thereof in the prior art;

FIG. 2 is a schematic view showing appearance of an electronic apparatus and a base thereof of the present invention;

FIG. 3 is a schematic view showing appearance of an electronic apparatus and a base thereof according to a first embodiment of the present invention;

FIG. 4A is a top view showing a double-row connector;

FIG. 4B is a side view showing a single-row connector;

FIG. 5A is a schematic view of forward connecting the electronic apparatus with the base;

FIG. 5B is a schematic view of forward inserting a second connector of the electronic apparatus with a first connector of the base;

FIG. 6A is a schematic view of reverse connecting the electronic apparatus with the base;

FIG. 6B is a schematic view of reverse inserting a second connector of the electronic apparatus with a first connector of the base;

FIG. 7 is a schematic view showing appearance of an electronic apparatus and a base thereof according to a second embodiment of the present invention;

FIG. 8 is a schematic view showing appearance of an electronic apparatus and a base thereof according to a third embodiment of the present invention; and

FIG. 9 is a flowchart showing a method of switching pin functions of connector according to the first embodiment of the present invention.

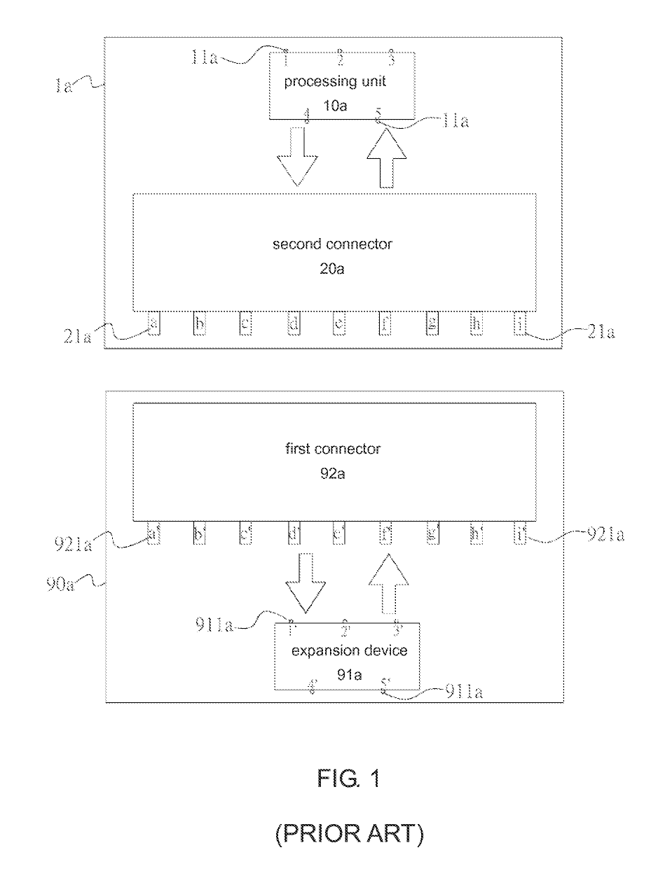

### DETAILED DESCRIPTION OF THE INVENTION

Specific embodiments of the present invention are further described in the following and cooperated with the attached figures for allowing the abovementioned, other aspects, features and advantages of the present invention to be easily understood.

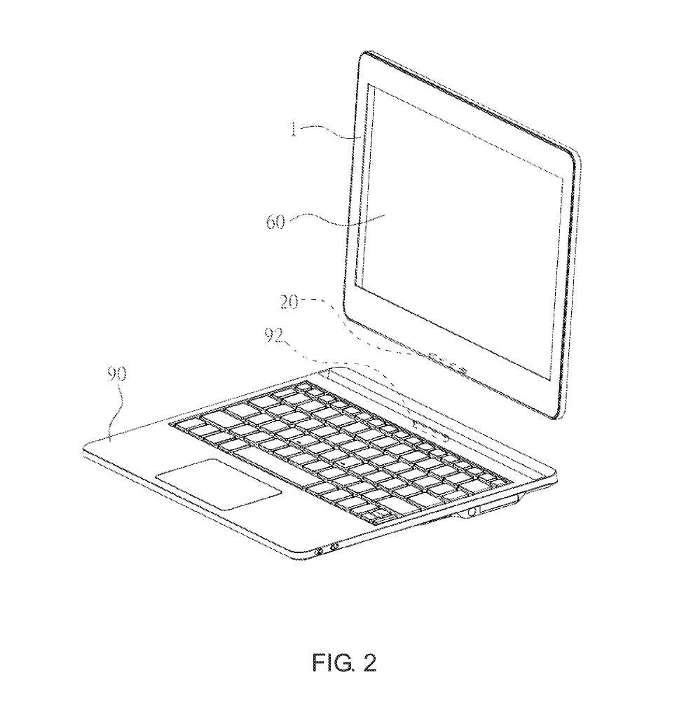

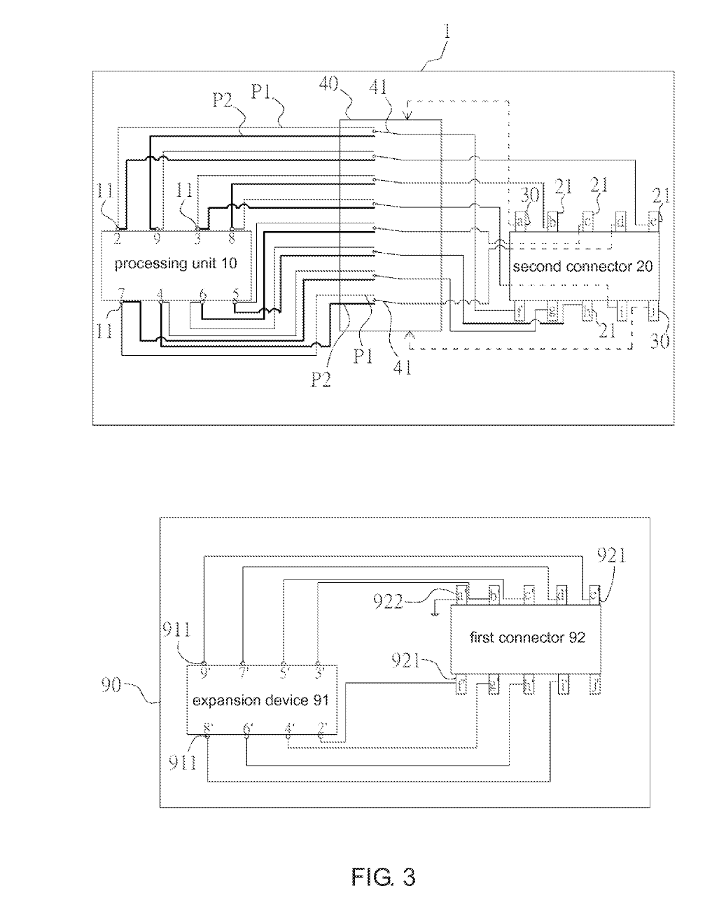

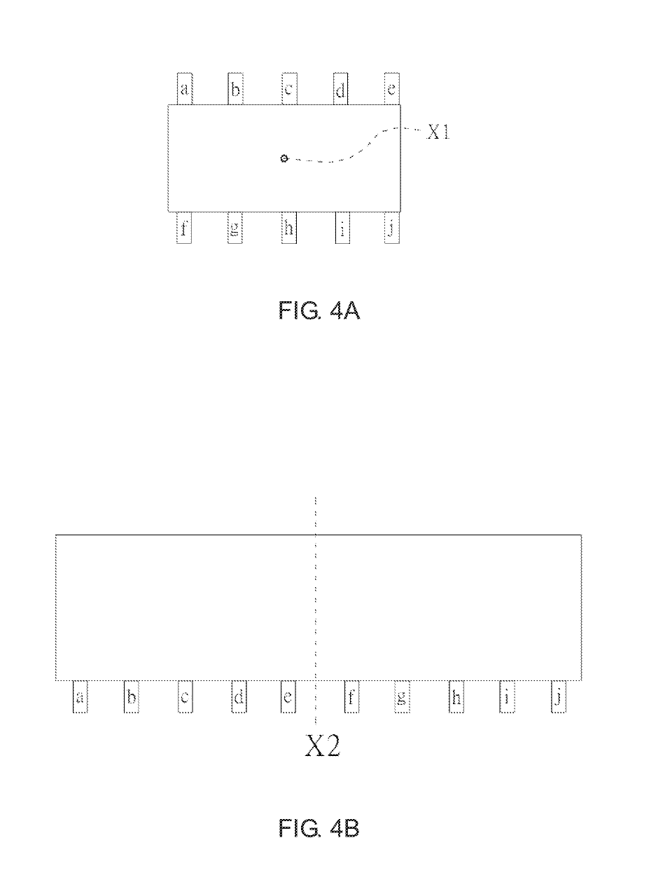

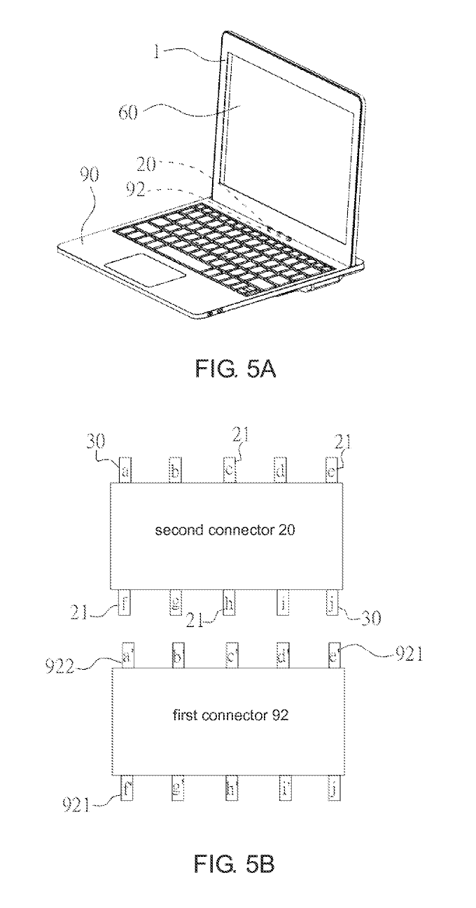

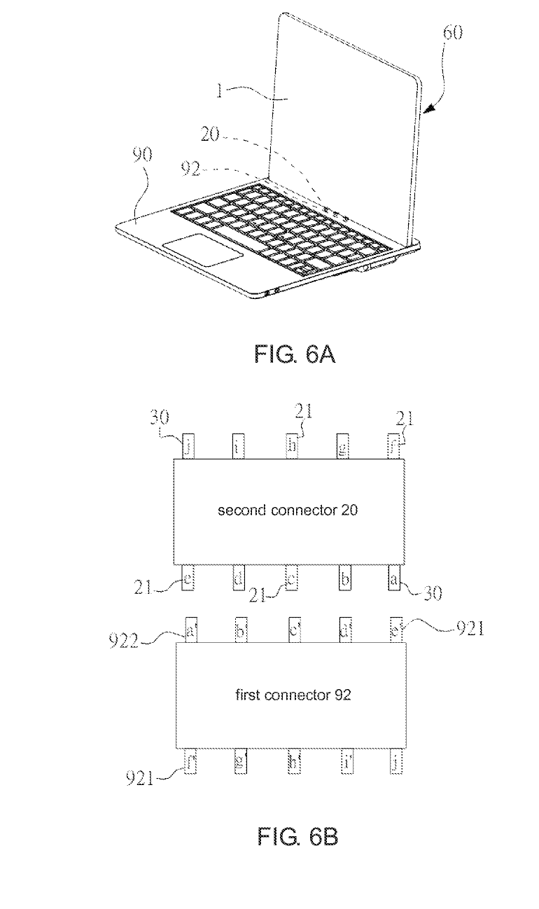

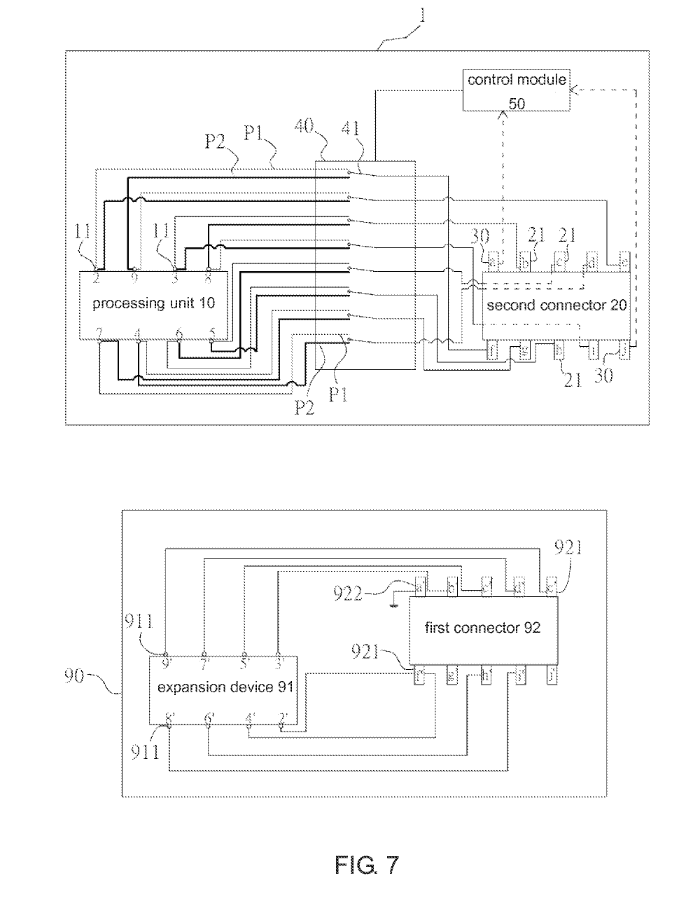

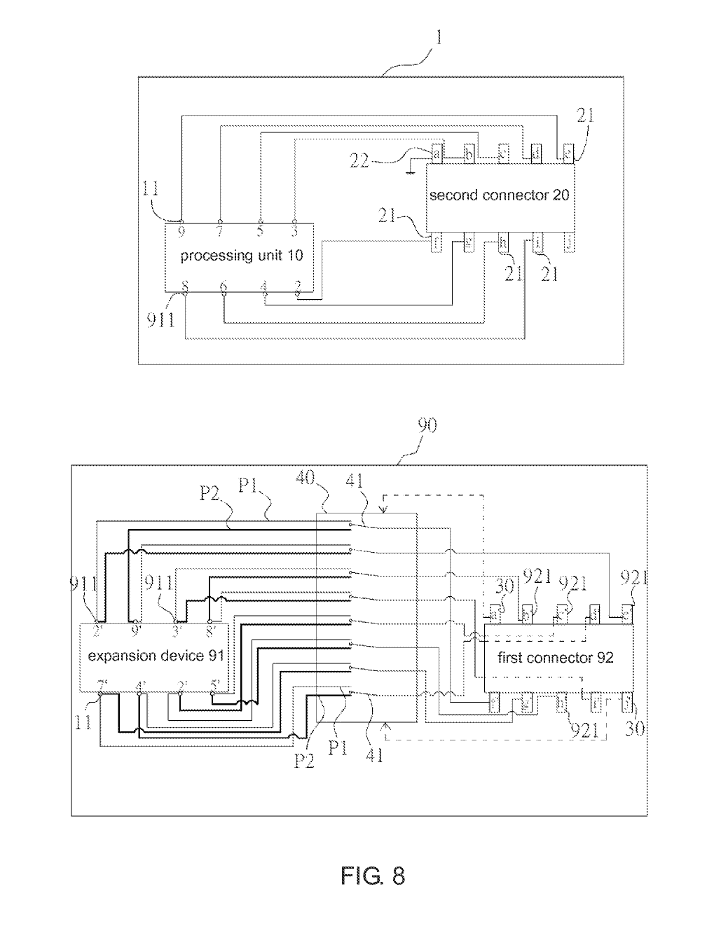

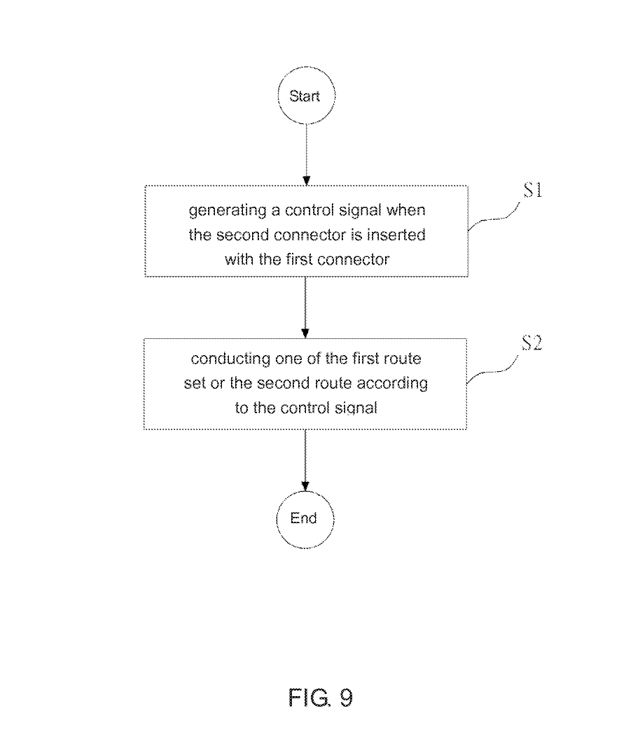

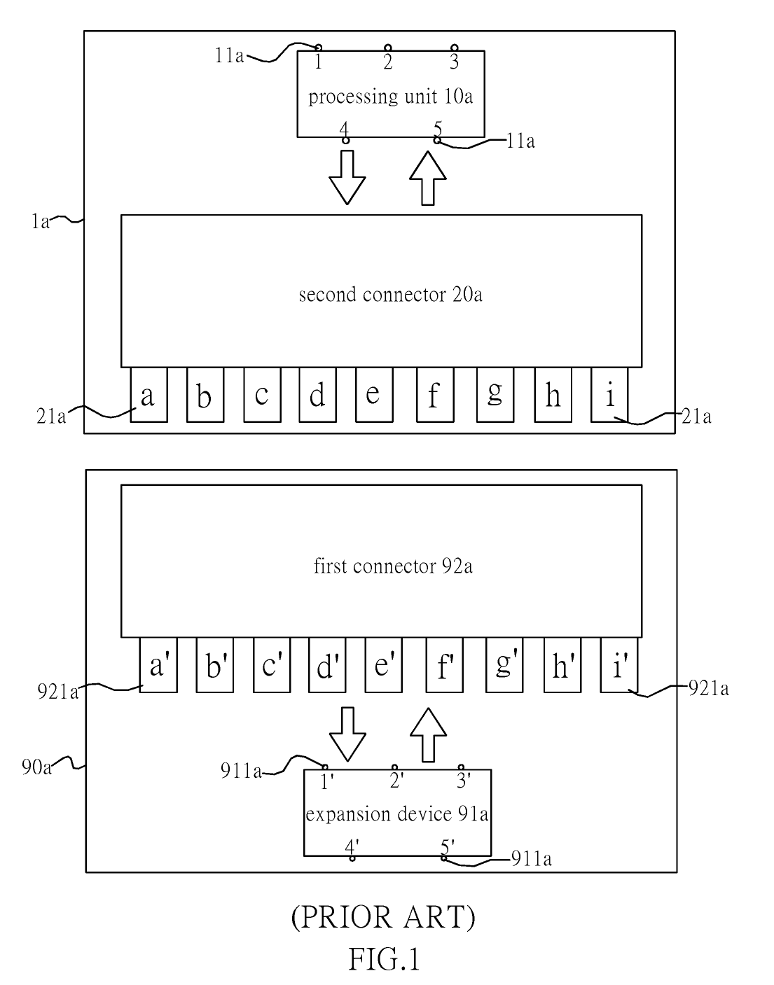

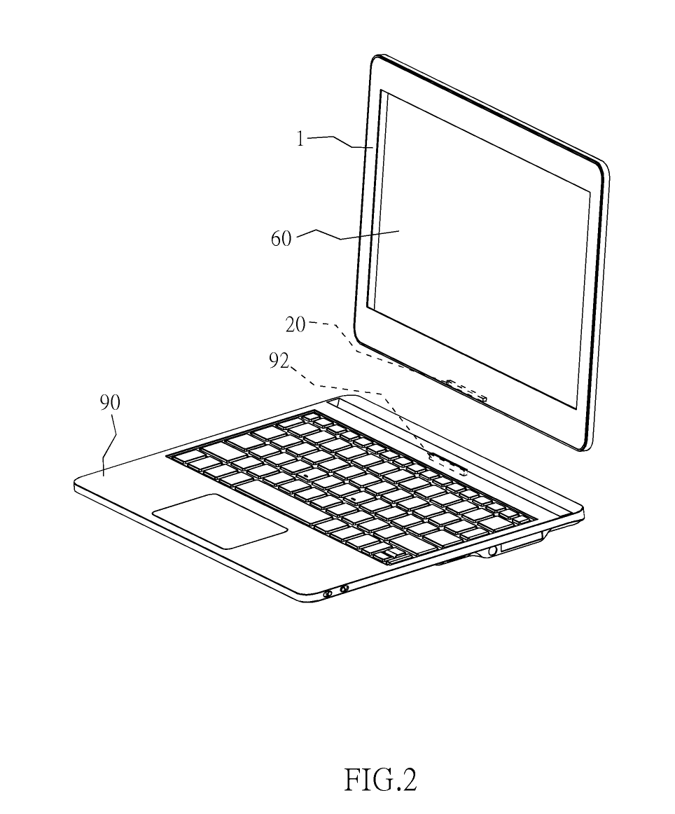

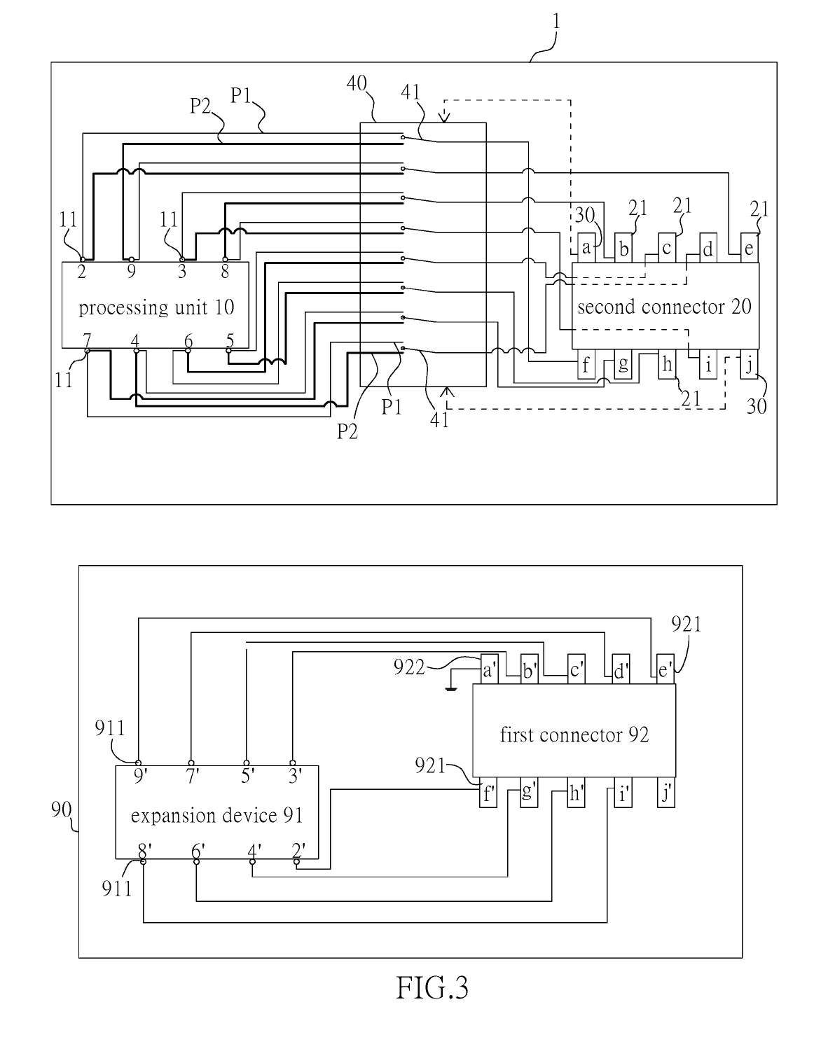

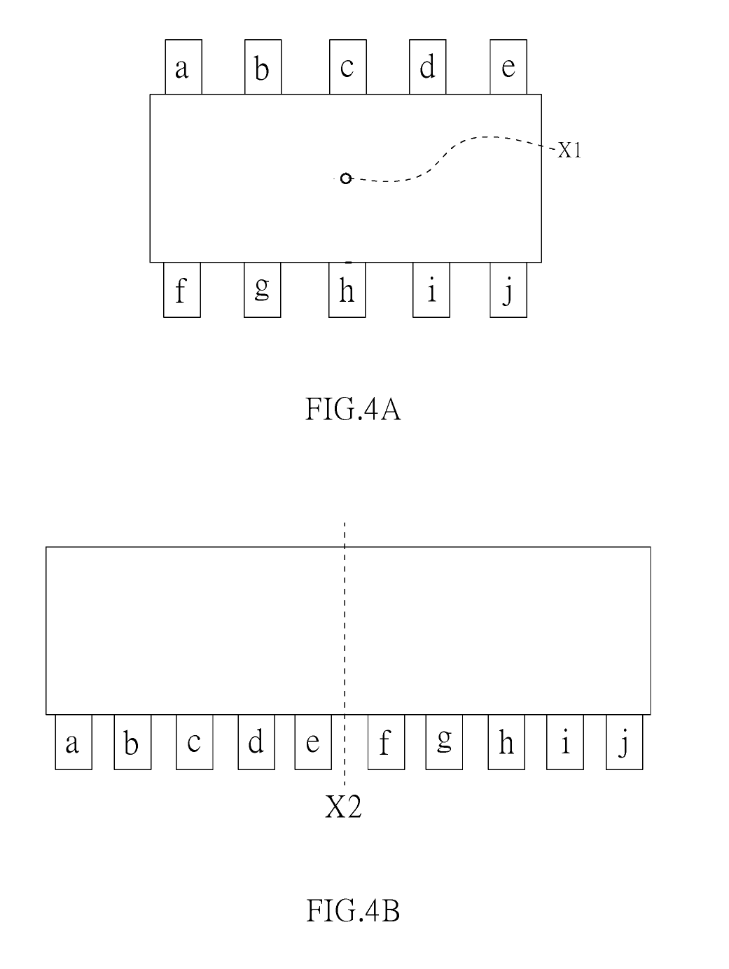

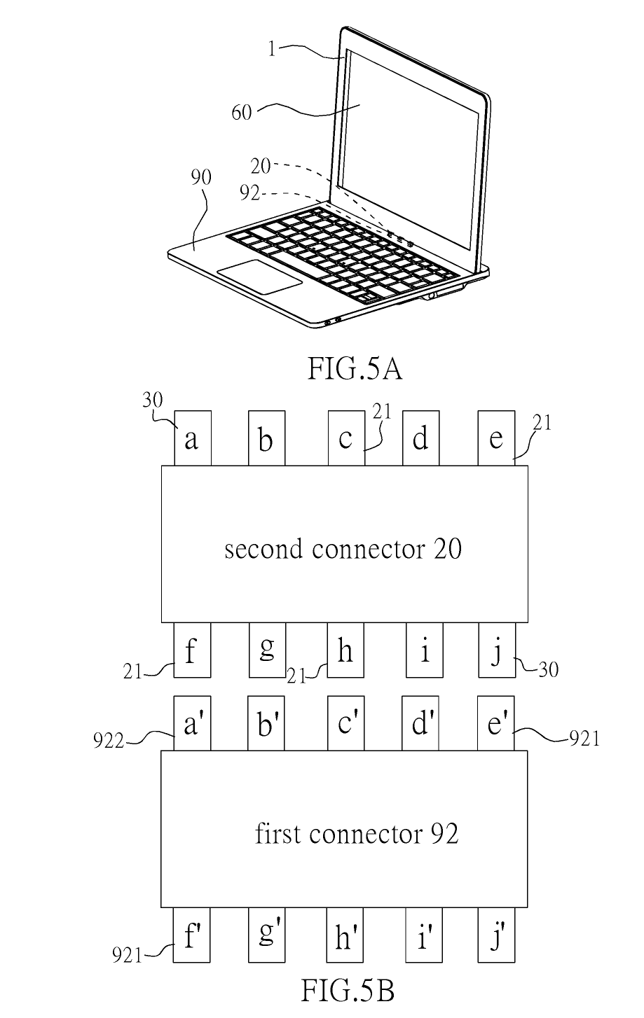

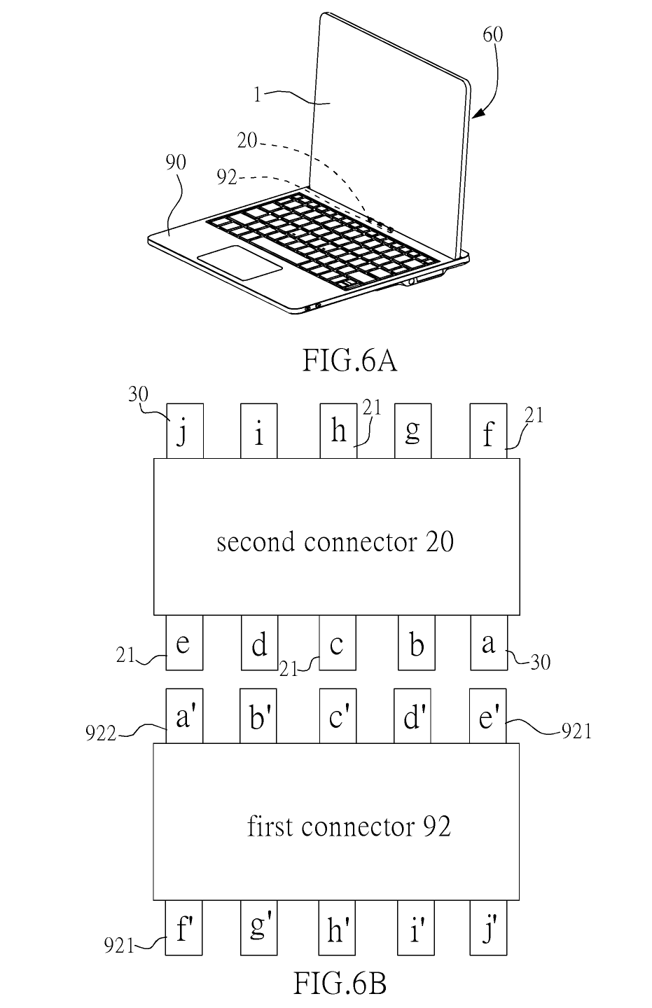

Please refer from FIG. 2 to FIG. 6B first, in which FIG. 2 is a schematic view showing appearance of an electronic apparatus and a base thereof of the present invention, FIG. 3 is a schematic view showing appearance of an electronic apparatus and a base thereof according to a first embodiment of the present invention, FIG. 4A is a top view showing a double-row connector, FIG. 4B is a side view showing a single-row connector, FIG. 5A is a schematic view of forward connecting the electronic apparatus with the base, FIG. 5B is a schematic view of forward inserting a second connector of the electronic apparatus with a first connector of the base, FIG. 6A is a schematic view of reverse connecting the electronic apparatus with the base and FIG. 6B is a schematic view of reverse inserting a second connector of the electronic apparatus with a first connector of the base.

As shown in FIGS. 2, 5A and 6A, the electronic apparatus I of the present invention is detachably connected with a base 90. And further, the electronic apparatus 1 can be forward connected with the base 90 by allowing a display surface 60 to be toward ahead (as shown in FIG. 5A) or reverse connected with the base 90 by allowing a display surface 60 to be toward behind (as shown in FIG. 6A). As shown in FIGS. 2 and 3, the base 90 comprises an expansion device 91 and a first connector 92. The expansion device comprises a plurality of input/output contacts 911 for receiving or outputting a signal, and then the first connector 92 comprises a plurality of first transmission pins 921 and a first ground pin 922. Each of the input/output contacts 911 is electrically connected with each of the first transmission pins 921, and the first ground pin 922 is grounded. In a specific embodiment of the present invention, the electronic apparatus 1 is a tablet and the expansion device 91 is a keyboard. However, the present invention is not limited thereto. That is, the expansion device 91 also can be a horn or any other devices for expanding function of the computer. In the specific embodiment of the present invention, the amount of the input/output contacts 911 is 8, which are respectively shown in FIG. 3 and indicated by number 2′˜9′, however, the amount of the input/output contacts 911 of the present invention is not limited thereto. In the specific embodiment of the present invention, the amount of the first transmission pins 921 is also 8, which are respectively shown in FIG. 3 and indicated number however, the amount of the first transmission pins 921 of the present invention is not limited thereto.

In a first embodiment of the present invention, the electronic apparatus 1 of the present invention comprises a processing unit 10, a second connector 20, a sensing module 30 and a. route-selecting module 40.

In the first embodiment of the present invention, the processing unit 10 has a plurality of input/output terminals 11. In the specific embodiment of the present invention, the amount of the input/output terminals 11 is 8, which are respectively shown in FIG. 3 and indicated by number 2˜9, however, the amount of the input/output terminals 11 of the present invention is not limited thereto. In order to clarify the explanation the input/output terminal 11 (number 2) of the processing unit 10 is electrically connected with the input/output contact 911 (number 2′) of the expansion device 91, the input/output terminal 11 (number 3) of the processing unit 10 is electrically connected with the input/output contact 911 (number 3′) of the expansion device 91 and so on when the processing unit 10 needs to perform a signal transmission with the expansion device 91 in the present embodiment. The purpose of the following illustration is to illustrate how each of the input/output terminals 11 can be electrically connected with the corresponding input/output contact 911 to allow the processing unit 10 performing the signal transmission with the expansion device 91 during both the forward insertion and the reverse insertion between the connectors.

In the first embodiment of the present invention, the second connector 20 can be forward (as show in FIG. 5B) or reverse (as shown in FIG. 6B) inserted with the first connector 92. The second connector 20 comprises a plurality of second transmission pins 21. The forward insertion or the reverse insertion disclosed in the present invention means two connection situations of inserting one connector with the other connector before and after it is rotated for 180 degrees by using a fixed axis, which passes the center itself along the up and down direction, as an axis. In the specific embodiment of the present invention, the amount of the second transmission pins 21 is also 8, which are respectively shown in FIG. 3 and indicated by number b˜i, however, the amount of the second transmission pins 21 of the present invention is not limited thereto.

In the first embodiment of the present invention, the sensing module 30 is a pair of second sensing pins disposed on the second connector 20. Furthermore, the disposing positions of the two of the second sensing pins on the second connector 20 are symmetric. As show in FIGS. 4A and 4B, FIG. 4A is a top view showing a double-row connector and FIG. 4B is a side view showing a single-row connector. Such the two connectors are often seen recently The term “symmetric” used in the whole invention means that a pin of the connector will arrive at a position after rotating the connector for 180 degrees by using a fixed axis, which passes the center itself along the up and down direction, as an axis and further the abovementioned position is the same as an original position of the other pin before the rotation. Using FIG. 4A as an example, the pin (number a) will arrive at the original position of the pin (number j) after rotating the connector for 180 degrees by using a fixed axis X1 (the figure is a top view, therefore, the up to down direction means a direction penetrating the paper surface). That is, the pin (number a) and the pin (number j) are symmetric. Similarly; the pin (number g) and the pin (number d) are also symmetric. Using FIG. 4B as another example, the pin (number b) will arrive at the original position of the pin (number i) after rotating the connector for 180 degrees by using a fixed axis X2 (the figure is a side view, therefore, X2 means the fixed axis passing the center of the connector along the up to down direction). That is, the pin (number b) and the pin (number i) are symmetric. Similarly, the pin (number e) and the pin (number f) are also symmetric. As shown in FIG. 3, in the first embodiment of the present invention, two of the second sensing pins are the pins (number a and number j), respectively, of the second connector 20. However, the present invention is not limited as long as the disposing positions of the second sensing pins on the second connector 20 are symmetric. For example, two of the second sensing pins also can be the pins (number c and number h). At that time, the pins (number a and number j) will be used as the second transmission pins 21.

In the embodiment of the present invention, two of the second sensing pins will be connected with a direct current (not shown in the figure). As shown in FIG. 3, FIG. 5A and FIG. 5B when the second connector 20 is forward inserted with first connector 92, the second sensing pin (number a) of the second connector 20 will be contacted with the first ground pin 922 (number a′) of the first connector 92 for allowing current generated by the direct current to be grounded to turn the potential of the second sensing pin (number a) from high to low so that a first control signal is generated. On the other hand, as shown in FIG. 3, FIG. 6A and FIG. 6B, when the second connector 20 is reverse inserted with first connector 92, the second sensing pin (number j) of the second connector 20 will be contacted with the first ground pin 922 (number a′) of the first connector 92 for allowing current generated by the direct current to be grounded to turn the potential of the second sensing pin (number j) from high to low so that a second control signal is generated.

As shown in FIG. 3, in the first embodiment of the present invention, the route-selecting module 40 comprises a plurality of switch components 41. Each of the switch components 41 is electrically connected with each of the second transmission pins 21. Each of the switch components 41 is provided for allowing each of the input/output terminals 11 to be electrically connected with each of the second transmission pins 21 through a first route set P1 (as shown by non-thick lines in FIG. 3) or a second route set P2 (as shown by thick lines in FIG. 3). The route-selecting module 40 is connected with the sensing module 30 for controlling the switch components 41 to conduct one of the first route set P1 or the second route set P2 according to the first control signal or the second control signal so that each of the second transmission pins 21 can be electrically connected with each of the input/output terminals 11 through, selectively, the conduction of the first route set P1 or the second route set P2. A sort of the first route set P1 and the second route set P2, respectively, corresponding to each of the input/output terminals 11 is different, and a sort of the first route set P1 and the second route set P2, respectively, corresponding to each of the second transmission pins 21 is the same. In particular, when each of the second transmission pins 21 (number b˜i) is electrically connected with the input/output terminals 11 through the first route set P1, a corresponding sort is 3, 5, 7, 9, 2, 4, 6 and 8. Furthermore, when each of the second transmission pins 21 (number b˜i) is electrically connected with the input/output terminals 11 through the second route set P2, a corresponding sort is 8, 6, 4, 2, 9, 7, 5 and 3. Accordingly, the sorts of the first route set P1 and the second route set P2, respectively, corresponding to each input/output terminal 11 are different.

As shown in FIG. 3, the input/output terminal 11 (number 2) of the processing unit 10 can be electrically connected with one of the second transmission pin 21 (number f) and the second transmission pin 21 (number e) of the second connector 20 through one route of the first route set P1 or one route of the second route set P2 by the control of a switch component 41, in which the second transmission pin 21 (number f) and the second transmission pin 21 (number e) are symmetric as mentioned above. Similarly, the input/output terminal 11 (number 9) of the processing unit 10 also can be electrically connected with one of the second transmission pin 21 (number f) and the second transmission pin 21 (number e) of the second connector 20 through another route of the first route set P1 or another route of the second route set P2 by the control of the switch component 41. The second transmission pin 21 (number f) is electrically connected with the input/output terminal 11 (number 2), which the second transmission pin 21 (number e) is electrically connected with through the second route set P2, through the first route set P1. The design between the input/output terminals 11 with other numbers and the second transmission pin 21 is the same, and therefore, there is no further description. In the specific embodiment of the present invention, the route-selecting module 40 is a switch IC, however, the present invention is not limited thereto.

When the second connector 20 is forward inserted with the first connector 92, as mentioned above, the potential of the second sensing pin (number a) of the second connector 20 will be varied (that is, the first control signal is generated). At that time, the route-selecting module 40 will control each switch component 41 according to the first control signal to conduct the transmission routes as shown by non--thick lines in FIG. 3 (the first route set P1) for allowing the input/output terminal 11 (number 2) of the processing unit 10 to output a signal to the input/output contact 911 (number 2′) of the expansion device 91 through the insertion between the two connectors or to receive a signal transmitted from the input/output contact 911 (number 2′) of the expansion device 91. Under the forward insertion between the two connectors, other input/output terminals 11 also can be electrically connected with the corresponding input/output contact 911 through the conduction of the first route set P1. For example, the input/output terminal 11 (number 5) can be electrically connected with the input/output contact (number 5′). and the input/output terminal 11 (number 7) can be electrically connected with the input/output contact (number 7′).

On the other hand, when the second connector 20 is reverse inserted with the first connector 92, as mentioned above, the potential of the second sensing pin (number j) of the second connector 20 will be varied (that is, the second control signal is generated). At that time, the route-selecting module 40 will control each switch component 41 according to the second control signal to conduct the transmission routes as shown by thick lines in FIG. 3 (the second route set P2). Because the second transmission pin 21 (number 1) does not be contacted with the first transmission pin 921 (number f′) of the first connector 91 anymore when the second connector 20 is reverse inserted with the first connector 92 and is contacted with the first transmission pin 921 (number e′), the input/output terminal 11 (number 2) of the processing unit 10 cannot perform the signal transmission with the input/output contact 911 (number 2′) of the expansion device 91 through the contact between the second transmission pin 21 (number f) and the first transmission pin 921 (number f′). However, the input/output terminal 11 (number 2) is electrically connected with the second transmission pin 21 (number e) through one route of the second route set P2 at that time, and the second transmission pin 21 (number e) is contacted with the first transmission pin 921 (number f′) during the reverse insertion. Therefore, the input/output terminal 11 (number 2) still can perform the signal transmission with the input/output contact 911 (number 2′) through the contact between the second transmission pin 21 (number e) and the first transmission pin 921 (number f′). Other input/output terminals 11 also can be electrically connected with the corresponding input/output contact 911 according to the same design. For example, the input/output terminal 11 (number 5) can be electrically connected with the input/output contact (number 5′), and the input/output terminal 11 (number 7) can be electrically connected with the input/output contact (number 7′).

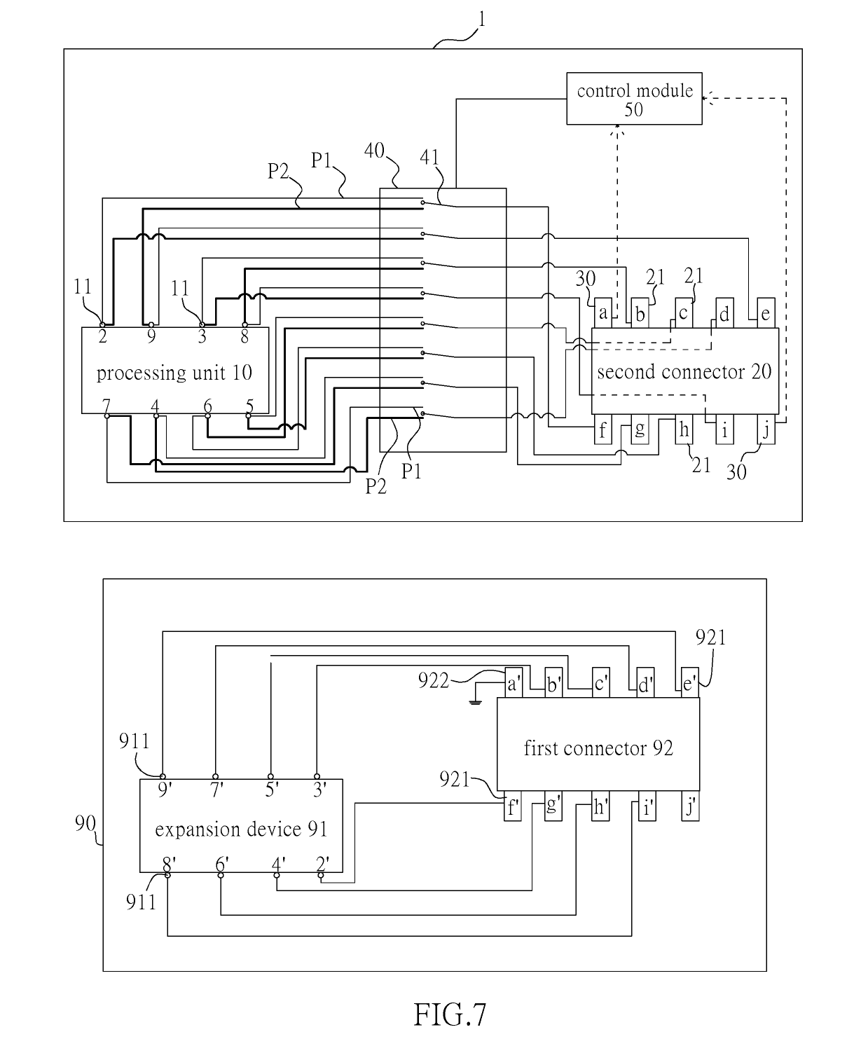

And then, please refer to FIG. 7. FIG. 7 is a schematic view showing appearance of an electronic apparatus and a base thereof according to a second embodiment of the present invention.

As shown in FIG. 7, in the second embodiment of the present invention, a difference from the abovementioned first embodiment is that the electronic apparatus 1 further comprises a control module 50. The control module 50 is electrically connected with the sensing module 30 and the route-selecting module 40 and provided for controlling the route-selecting module 40 according to the first control signal or the second control signal to conduct one of the first route set P1 or the second route set P2. In the specific embodiment of the present invention, the control module 50 is an embedded controller (EC), however, the present invention is not limited thereto. Because the difference between the first embodiment and the second embodiment of the present invention is only to control the route-selecting module 40 through the control module 50 and the determination of conducting the first route set P1 or the second route set P2 is the same as the abovementioned first embodiment, there is no further description herein.

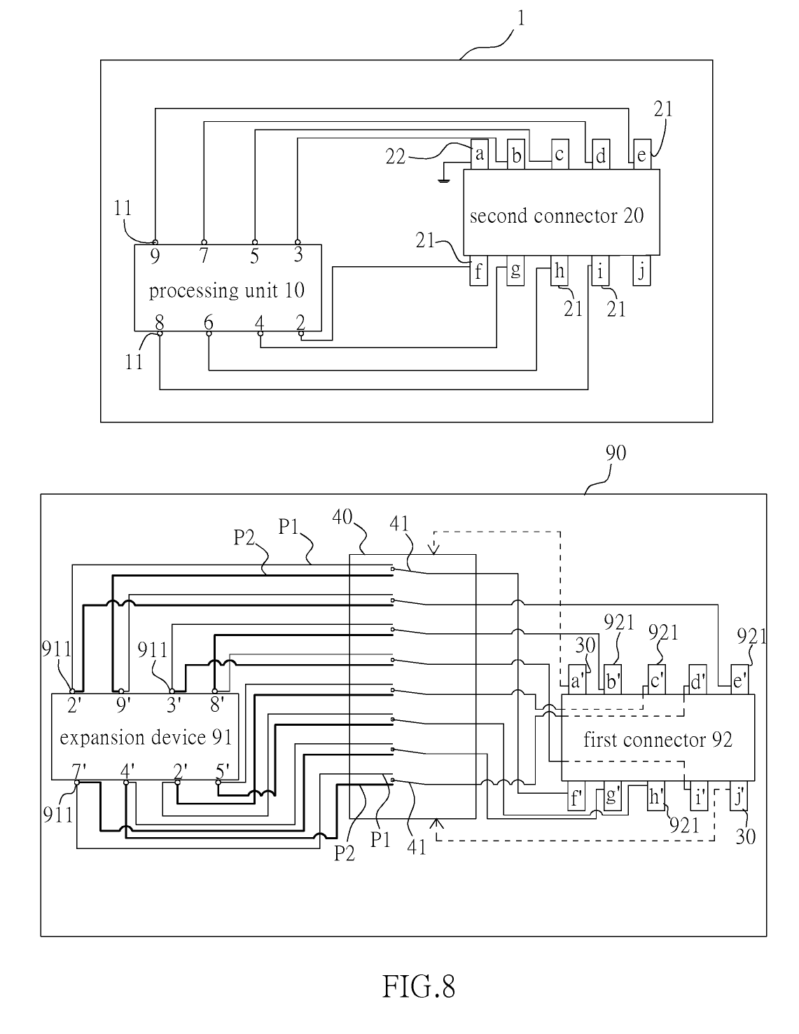

Please refer to FIG. 8. FIG. 8 is a schematic view showing appearance of an electronic apparatus and a base thereof according to a third embodiment of the present invention.

As shown in FIG. 8, in the third embodiment of the present invention, a difference from the abovementioned first embodiment is that the sensing module 30 and the route-selecting module 40 are disposed at the base 90. The route-selecting module 40 is electrically connected with each of the first transmission pins 921 and the sensing module 30. The route-selecting module 40 is provided for allowing the first route set P1 (as shown by non-thick lines in FIG. 8) to be conducted according to the first control signal generated by the sensing module 30 or for allowing the second route set P2 (as shown by thick lines in FIG. 8) to be conducted according to the second control signal to allow each of the first transmission pins 921 to be electrically connected with each of the input/output contacts 911 through the conduction of the first route set P1 or the second route set P2. A sort of the first route set P1 and the second route set P2, respectively, corresponding to each of the input/output contacts 911 is different, and a sort of the first route set P1 and the second route set P2, respectively, corresponding to each of the first transmission pins 921 is the same. In the third embodiment of the present invention, the sensing module 30 is a pair of first sensing pins disposed on the first connector 92. Furthermore, the disposing positions of the two of the first sensing pins on the first connector 92 are symmetric. The second connector 20 comprises a second ground pin 22, and the second ground pin 22 can be contacted with each of the first sensing pins, respectively, when the second connector 20 is forward or reverse inserted with the first connector 92. Because the third embodiment is to perform the control mechanism, which is originally performed in the electronic apparatus 1, in the base 90 and the determination of conducting the first route set P1 or the second route set P2 is the same as the abovementioned first embodiment, there is no further description herein.

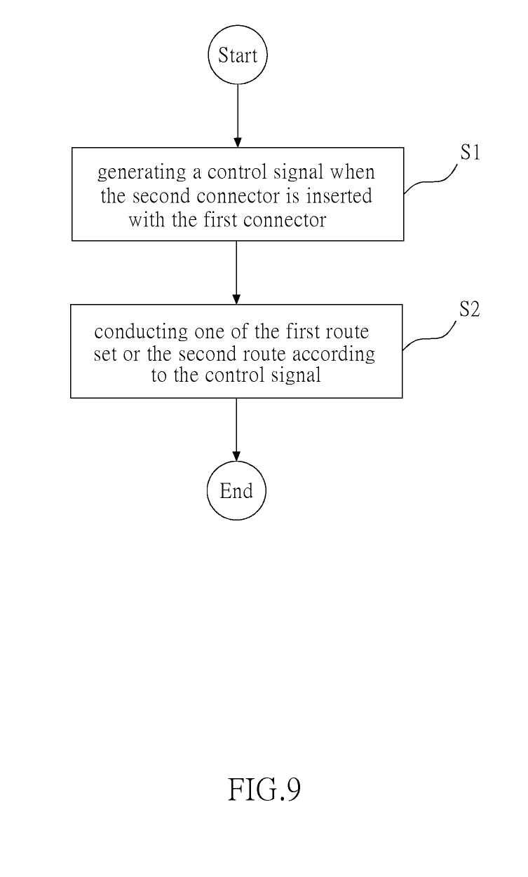

Please further refer to FIG. 3, FIG. 8 and FIG. 9, in which FIG. 9 is a flowchart showing a method of switching pin functions of connector according to the first embodiment of the present invention. The following will describe each of steps shown in FIG. 9 by cooperating with FIG. 3. It is noted that the present invention is not limited to be applied in the abovementioned electronic apparatus 1 and the base 90 although the method of switching pin functions of connector according to the present invention is described by using the electronic apparatus 1 and the base 90 shown in FIG. 3 as an example. That is, the method of switching pin functions of connector according to the present invention also can be performed in the electronic apparatus 1 and the base 90 as shown in FIG. 8.

First, a step S1 of generating a control signal is performed when the second connector is inserted with the first connector.

As shown in FIG. 3, in an embodiment of the present invention, as mentioned above, a control signal will be generated through the sensing module 30 When the second connector 20 is inserted with the first connector 92. When the second connector 20 is forward inserted with the first connector 92, the control signal will be generated from the second sensing pin (number a) of the second connector 20. On the other hand, the control signal will be generated from the second sensing pin (number j) of the second connector 20 if the second connector 20 is reverse inserted with the first connector 92. That is to say, the control signal is different according to the forward insertion or the reverse insertion between the second connector 20 and the first connector 92.

And then, a step S2 is performed to conduct the first route set or the second route set according to the control signal.

As shown in FIG. 3, in an embodiment of the present invention, different second sensing pins generate the control signal, respectively, when the second connector 20 is forward inserted with and reverse inserted with the first connector 92. Therefore, the route-selecting module 40 can conduct one of the first route set P1 or the second route set P2 according to the source of the control signal. That is to say, in the embodiment of the present invention, when the control signal is generated by the second sensing pin (number a) (that is, the first control signal is generated), the route-selecting module 40 will conduct the first route set P1 according to the control signal, as mentioned above, due to the forward insertion between the second connector 20 and the first connector 92. Therefore, the processing unit 10 can perform a signal transmission with the expansion device 91 through the conduction of the first route set P1. And then, when the control signal is generated by the second sensing pin (number j) (that is, the second control signal is generated), the route-selecting module 40 will conduct the second route set P2 according to the control signal, as mentioned above, due to the reverse insertion between the second connector 20 and the first connector 92. Therefore, the processing unit 10 can perform a signal transmission with the expansion device 91 through the conduction of the second route set P2.

By the abovementioned steps, the function of the second transmission pin of the second connector 20 is capable of being duly changed according to the insertion status between the second connector 20 and the first connector 92 (the forward insertion or the reverse insertion). For example, it presumes that the input/output terminal 11 (number 2) of the processing unit 10 is provided for outputting the signal, and the input/output terminal 11 (number 9) is provided for receiving the signal. When the second transmission pin 21 (number f) of the second connector 20 is electrically connected with the input/output terminal 11 (number 2) through one route of the first route set, it is used for outputting the signal to the first connector 92. When the second transmission pin 21 (number f) of the second connector 20 is electrically connected with the input/output terminal 11 (number 9) through one route of the second route set, it is used for receiving the signal transmitted from the first connector 92.

According to the abovementioned, the first connector 92 or the second connector 20 of the present invention can utilize the sensing module 30 and the route-selecting module 40 to allow the processing unit 10 performing the signal transmission with the expansion device 91 during both the forward insertion and the reverse insertion. In the present invention, double amount of pins is not necessary and the problems of the prior art are effectively avoided.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic apparatus detachably connected with a base, wherein the base comprises an expansion device and a first connector electrically connected with the expansion device, comprising:
a processing unit comprising a plurality of input/output output terminals;
a second connector capable of being forward or reverse inserted with the first connector and comprising a plurality of second transmission pins;
a sensing module provided for generating a first control signal when the second connector is forward inserted with the first connector and for generating a second control signal when the second connector is reverse inserted with the first connector; and
a route-selecting module connected with the sensing module and provided for conducting a first route set according to the first control signal or for conducting a second route set according to the second control signal to allow each of the second transmission pins to be electrically connected with each of the input/output terminals through, selectively, the conduction of the first route set or the second route set,
wherein a sort of the first route set and the second route set, respectively, corresponding to each of the input/output terminals is different and a sort of the first route set and the second route set, respectively, corresponding to each of the second transmission pins is the same so that the processing unit can perform a signal transmission with the expansion device through, respectively, the conduction of the first route set or the second route set when the second connector is forward or reverse inserted with the first connector.

2. The electronic apparatus according to claim 1, wherein the sensing module is a pair of second sensing pins disposed on the second connector and the disposing positions thereof on the second connector are symmetric.

3. The electronic apparatus according to claim 2, wherein route-selecting module is a switch IC.

4. The electronic apparatus according to claim 3, further comprising a control module electrically connected with the sensing module and the route-selecting module for controlling the route-selecting module to conduct one of the first route set or the second route set according to the first control signal or the second control signal.

5. A base detachably connected with an electronic apparatus, wherein the electronic apparatus comprises a processing unit and a second connector electrically connected with the processing unit, comprising:
an expansion device comprising a plurality of input/output contacts;
a first connector capable of being forward or reverse inserted with the second connector and comprising a plurality of first transmission pins;
a sensing module provided for generating a first control signal when the second connector is forward inserted with the first connector and for generating a second control signal when the second connector is reverse inserted with the first connector; and
a route-selecting module connected with the sensing module and provided for conducting a first route set according to the first control signal or for conducting a second route set according to the second control signal to allow each of the first transmission pins to be electrically connected with each of the input/output contacts through, selectively, the conduction of the first route set or the second route set,
wherein a sort of the first route set and the second route set, respectively, corresponding to each of the input/output contacts is different and a sort of the first route set and the second route set, respectively, corresponding to each of the first transmission pins is the same so that the expansion device can perform a signal transmission with the processing unit through, respectively, the conduction of the first route set or the second route set when the second connector is forward or reverse inserted with the first connector.

6. The base according to claim 5, wherein the sensing module is a pair of first sensing pins disposed on the first connector and the disposing positions thereof on the first connector are symmetric.

7. The base according to claim 6, wherein the route-selecting module is a switch IC.

8. The base according to claim 7, further comprising a control module electrically connected with the sensing module and the route-selecting module for controlling the route-selecting module to conduct one of the first route set or the second route set according to the first control signal or the second control signal.

9. A method of switching pin functions of connector for allowing a processing unit of an electronic apparatus performing a signal transmission with an expansion device of a base when a second connector of the electronic apparatus is forward or reverse inserted with a first connector of the base, wherein the processing unit comprises a plurality of input/output terminals, the second connector comprises a plurality of second transmission pins and each of the second transmission pins is electrically connected with each of the input/output terminals through, selectively, conduction of a first route set or a second route set, wherein a sort of the first route set and the second route set corresponding to, respectively, each of the input/output terminals is different and a sort of the first route set and the second route set, respectively, corresponding to each of the second transmission pins is the same, including:
generating a control signal when the second connector is inserted with the first connector, wherein the control signal is different according to the forward insertion or the reverse insertion between the second connector and the first connector; and
allowing one of the first route set or the second route to be conducted according to the control signal.

10. The method according to claim 9, wherein the control signal is generated by two of second sensing pins disposed on the second connector, respectively, according to the forward insertion or the reverse insertion between the second connector and the first connector and the disposing positions of the two of the second sensing pins on the second connector are symmetric.
